(19) United States
(12) Patent Application Publication
(10) Pub. No.: US 2015/0273523 A1
(43) Pub. Date: Oct. 1, 2015

(54) METHOD OF PRODUCING MATERIALS FOR DISPOSAL OF ANIMAL EXCREMENT

(71) Applicant: Unicharm Corporation, Ehime (JP)

(72) Inventors: Takeshi Ikegami, Kagawa (JP); Kenji Hiroshima, Kagawa (JP)

(21) Appl. No.: 14/230,407

(22) Filed: Mar. 31, 2014

(51) Int. Cl. B05D 3/12; B05D 1/28; A01K 1/015; B05D 1/02

(52) U.S. Cl. CPC B05D 3/12; B05D 1/02; B05D 1/28; A01K 1/0152

(57) ABSTRACT

It is an object of the present invention to provide a method of producing materials for disposal of animal excrement comprising an aromatic material and granules comprising a water-absorbing base material, whereby the aromatic material can reliably adhere onto the surfaces of the granules with suitable coverage, and the working environment is not potentially impaired by fly-off of the aromatic material. The production method of the invention comprises the steps of: partially adhering an aromatic material (2) onto granules (1), and transferring aromatic material (2) adhered on one granule to another by vibrating the granules partially adhering the aromatic material (2).

### TECHNICAL FIELD

The present invention relates to a method of producing materials for disposal of animal excrement that comprises an aromatic material and a plurality of granules containing water-absorbing base materials, and to a material for disposal of animal excrement that is obtained by the production method.

### BACKGROUND ART

In the prior art, toilets for pet animals, such as dogs and cats, have employed materials for disposal of excrement comprising water-absorbing granules laid out in a box-shaped container. The materials for disposal of excrement used in such pet animal toilets are generally formed so as to rapidly absorb excreta, such as feces and urine, excreted by animals. Among such materials, there are also used materials for disposal of animal excrement that contain added aromatic materials in the water-absorbing granules, in order to eliminate bad odors generated from the excreta by the fragrance of the aromatic materials.

As a method of producing materials for disposal of excrement containing such an aromatic material, for example, PTL 1 discloses a method in which the surfaces of coarse grains with water absorption provided by granulating plant fiber or plant powder, are sprayed with a liquid aromatic material and a liquid aromatic material volatilization-inhibiting material, to form an aromatic material impregnation layer on the surface layer section of the coarse grains.

### CITATION LIST

### Patent Literature

[PTL 1] Japanese Unexamined Patent Publication No. 2004-033047

### SUMMARY OF INVENTION

### Technical Problem

The means for adhering a liquid aromatic material onto the surface of such granules is generally accomplished by using a rotating stirring mixer to stir the granules while supplying the aromatic material from above the granules. Specifically, a prescribed amount of granules is introduced into the mixing vessel of the stirring mixer, and then the granules are stirred by stirring means that rotates inside the mixing vessel, while the liquid aromatic material is sprayed from above the granules. By spraying the aromatic material while stirring the granules in this manner, the aromatic material adheres uniformly onto the granules.

However, in methods where such granules are sprayed with a liquid aromatic material while stirring, the liquid aromatic material 2 excessively adheres onto parts of the surface of the granules 1, as shown in FIG. 3. The locally adhering aromatic material 2 becomes impregnated in the interior of the granules 1, locally forming an aromatic material impregnation layer 3. Because the aromatic material impregnation layer 3 is fragile and easily degraded, the aromatic material impregnation layer 3 easily degrades in such methods, forming an aromatic material 2-rich powder 4, and it has not been possible for the aromatic material 2 to reliably adhere onto the surfaces of the granules 1.

In addition, when the aromatic material 2 is uniformly sprayed on the granules 1 that are being stirred in the rotating stirring mixer, the fine aromatic material 2 particles that have been sprayed tend to fly off, and furthermore since the granules 1 are stirred by the stirring mixer, the sprayed aromatic material 2 has tended to fly off around the stirring mixer, thus impairing the working environment.

Having been accomplished in light of these problems, it is an object of the present invention to provide a method of producing materials for disposal of animal excrement comprising an aromatic material and granules comprising water-absorbing base materials, whereby the aromatic material can reliably adhere onto the surfaces of the granules with suitable coverage, and the working environment is not potentially impaired by fly-off of the aromatic material. It is another object of the invention to provide materials for disposal of animal excrement having an excellent aromatic property and deodorant property, obtained by the production method of the invention.

### Solution to Problems

The invention is a method of producing materials for disposal of animal excrement comprising an aromatic material and granules comprising water-absorbing base materials, comprising the steps of: partially adhering the aromatic material onto the granules, and transferring aromatic material adhered on one granule to another by vibrating the granules partially adhering the aromatic material.

### Advantageous Effects of Invention

According to the production method of the invention, granules to which an aromatic material have partially adhered are vibrated so that the aromatic material adhering to one granule is transferred to another particle, and therefore instead of forming a local aromatic material impregnation layer that easily degrades, such as in the prior art, the aromatic material can be reliably adhered onto the surfaces of the granules to a suitable degree of coverage. In addition, since the aromatic material does not need to be uniformly sprayed onto the granules, there is no potential impairment of the working environment by fly-off of the aromatic material.

Furthermore, since the granules to be obtained by the production method of the invention do not have an easily degraded local aromatic material impregnation layer on the surfaces of the granules, unlike conventional granules, but rather the aromatic material reliably adheres onto the surfaces of the granules with a suitable degree of coverage, it is possible to significantly improve the aromatic property and deodorant property of materials for disposal of animal excrement.

### BRIEF DESCRIPTION OF DRAWINGS

FIG. 1 is a schematic diagram for one mode of the production method of the invention.

FIG. 2 is a schematic diagram for each of the steps in one mode of the production method of the invention.

FIG. 3 is a schematic diagram of a conventional production method.

### DESCRIPTION OF EMBODIMENTS

Preferred aspects of the production method of the invention will be explained below in detail with reference to the accompanying drawings.

According to one aspect of the invention, the materials for disposal of animal excrement are produced through a series of steps, namely a starting material preparation step in which the starting materials are treated and measured out, a starting material mixing step in which each of the starting materials is mixed in a mixer, a granulation step in which the mixture of the different starting materials is granulated into granules, a drying step in which the obtained granules are heat dried and optionally subjected to alkali treatment, a classifying step in which the granules are classified according to size, and an aromatic material adhering step in which the aromatic material is adhered onto the granules. The materials for disposal of animal excrement produced in this manner are made into a product through a packaging step in which the granules are packaged into prescribed amounts.

The invention further comprises, for the aromatic material adhering step, a step of partially adhering the aromatic material onto the granules, and a step of transferring aromatic material adhered on one granule to another by vibrating the granules partially adhering the aromatic material.

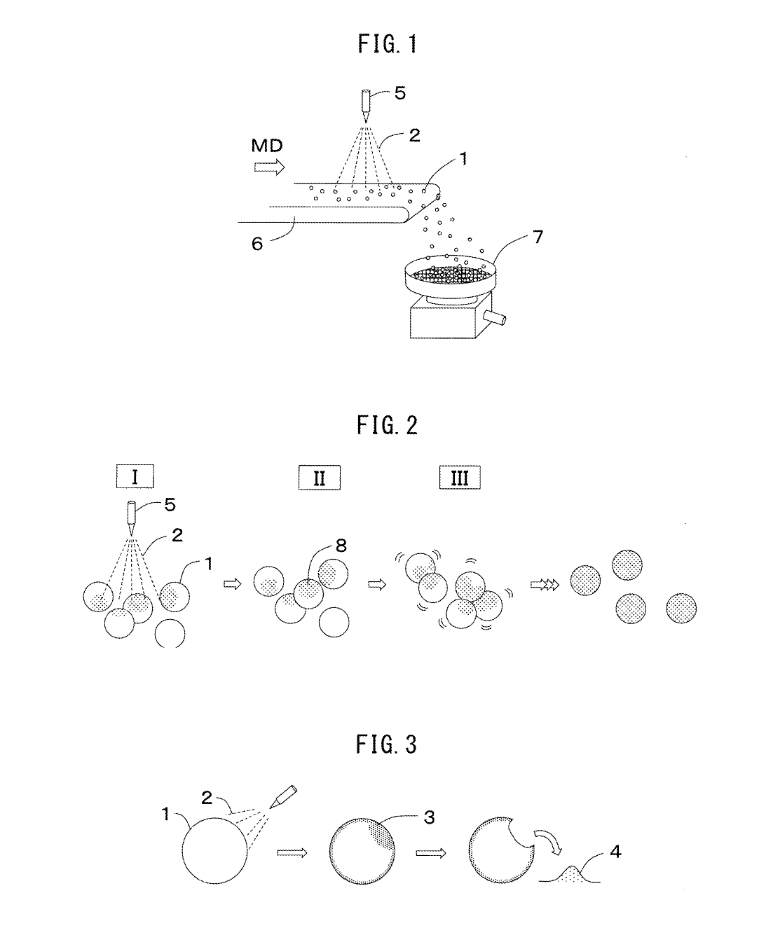

FIG. 1 is a schematic diagram for one aspect of the production method of the invention, and FIG. 2 is a schematic diagram showing the different steps for one aspect of the production method of the invention.

In FIG. 1, numeral 6 indicates conveying means, such as a belt conveyor, for continuous conveyance of granules 1 after the granulation step and drying step, along the prescribed machine direction MD, which is the downstream direction in the production steps. Numeral 5 indicates a supply nozzle provided above the conveying means 6, for supply of a prescribed amount of aromatic material 2 to the granules 1 being conveyed by the conveying means 6. Also, numeral 7 indicates a vibrator, such as a vibrating sieve, provided below the downstream end of the conveying means 6, to house the granules 1 falling from the edge of the downstream end of the conveying means 6 and vibrate the granules 1.

According to this aspect, step I is carried out in which the aromatic material 2 is supplied through the supply nozzle 5 set above the conveying means 6 while conveying the granules 1 in the prescribed machine direction MD by the conveying means 6, to partially adhere the aromatic material 2 to the granules 1. This is followed by step II in which the granules 1 to which the aromatic material 2 have been partially adhered are conveyed to the vibrator 7 and step III in which the granules 1 to which the aromatic material 2 has been partially adhered are vibrated in the vibrator 7, so that the aromatic material 2 adhered to one granule 1 is transferred to another granule 1.

There are no particular restrictions on the granules 1 comprising the water-absorbing base materials, and there may be used ones comprising any desired water-absorbing base material used in the prior art as a materials for disposal of animal excrement. The water-absorbing base material may be, for example, an inorganic material, such as bentonite, acidic white clay, silica gel, diatomaceous earth, diatomaceous shale, allophane, zeolite, sepiolite, attapulgite or any derivatives thereof, a plant-based material, such as paper, virgin pulp, regenerated pulp (pulp regenerated from paper), pulp sludge, bamboo, wood, corn, okara (soybean curd refuse), soybean, starch or the like, or a synthetic resin-based material having a water absorbing property, such as super-absorbent polymer. These materials may also be used in any desired combinations.

When an inorganic material, such as bentonite or acidic white clay, silica gel, diatomaceous earth or the like, has been used as the water-absorbing base material, such inorganic materials have excellent moisture absorption properties and adsorption properties and can therefore adequately exhibit a water absorption function as materials for disposal of animal excrement. In addition, such inorganic materials can impart to the granules 1 a degree of aromatic material impregnating ability that is suitable to allow the aromatic material 2 residing on the surfaces of the granules 1 (that is, the aromatic material 2 that has not been impregnated into the granules 1) to be transferred to each other on the surfaces, when the granules 1 are contacting each other, while the prescribed amount of aromatic material 2 is being impregnated into the granules 1, after the aromatic material 2 has been supplied to the granules 1.

When a plant-based material has been used as the water-absorbing base material, the scrap material from disposable diapers or the like during production may be utilized, or after use, it may be treated as biodegradable waste or thermally disposed as a combustible material, thereby reducing environmental load.

Also, the water-absorbing base material used may be a material comprising bentonite and/or acidic white clay treated with an alkali metal, such as sodium. Treatment of bentonite or acidic white clay with an alkali metal is known to speed the reaction and cause rapid heat release, and using such materials promotes volatilization of the aromatic components of the aromatic material 2, thus allowing odors generated from animal excreta to be more effectively suppressed. Furthermore, when such a mineral-based material has been used in the water-absorbing base material, the oil-absorbing property of the base material surface is lowered and the aromatic material more easily remains on the base material surface, such that in the aromatic material transfer step described hereunder, the aromatic material on the base material surface is easily transferred to another base material surface by vibration. Such materials are also advantageous because they expand in volume upon absorption of water, such that the surface area of the base material surface, i.e. the aromatic material-adhesion area, is enlarged by absorption of moisture present in excreta and a greater odor-suppressing effect is obtained.

In addition to the materials mentioned above, the water-absorbing base material may also have various components added that are included in materials for disposal of animal excrement in the prior art. Examples of such other components include pigments; antioxidants; antimicrobial agents, such as copper compounds, silver compounds, polyphenols and hydroxybenzoic acids; microbicides, such as triclosan, isopropylmethylphenol, benzalkonium chloride and isothiazolone; antiseptic agents; mildew resistant agents; and various plant extracts.

There are no particular restrictions on the form of the granules 1, and they may be spherical, cubic, cylindrical, (polygonal) columnar, granular, tablet-shaped or amorphous, and for functionality of the product, preferably granulation is carried out to the desired form according to the type and size of animal for which the materials for disposal of animal excrement are to be used, and the aspect of excretion, tendency toward fly-off and easy of handleability.

Also, there are no particular restrictions on the sizes of the granules 1, and granules of any desired size may be used. From the viewpoint of moisture absorption property and handleability, when the granules 1 are spherical, the mean particle diameter is preferably in the range of 0.5 to 10 mm, or when the granules 1 are cylindrical or (polygonal) columnar, the diameter or maximum length of the base is preferably in the range of 0.5 to 8 mm and the height is preferably in the range of 0.8 to 20 mm. The sizes, such as the particle diameters of the granules 1, can be determined by whether or not they pass through a sieve having an aperture of the prescribed size.

The granules 1 to be used for the invention are preferably porous bodies with multiple pores. The pores of the porous body can absorb and adsorb animal excreta, such as urine, and odors, such as ammonia and amine odors, produced from the excreta, while stably holding and gradually releasing the aromatic material in the pores. Therefore, when a porous body has been used for the granules 1, it is possible to effectively exhibit the aromatic property and deodorant property of the materials for disposal of animal excrement for prolonged periods.

There are also no particular restrictions on the sizes, shapes, directions and independence of the pores of the porous body; however, generally it will have pore diameters in the range of 0.01 to 100 μm.

As mentioned above, the granules 1 can be obtained by granulation of the mixture of the starting materials by any desired granulation means, after the starting material mixing step for the starting materials. For example, when an inorganic material, such as bentonite, is to be used as the water-absorbing base material, the granules 1 may be obtained by a granulation method comprising a step of compacting the mixture of the starting materials (for example, a method of extruding the mixture into strands and then cutting them into granules, or a method of directly compacting the mixture into granules). As a specific method of producing granules 1, there may be mentioned a granulation method using a disc pelleter, a briquet machine, a tableting machine or an extruder. Granulation allows easier control of the granule sizes and shapes compared to means such as crushing and can therefore yield granules with relatively uniform sizes, while the granule sizes can be easily adjusted, allowing the aromatic materials to be stably adhered onto the obtained granules 1. According to a different aspect, the granules 1 used may be commercially available ones.

The aromatic material 2 to be used for the invention may be any aromatic material with an aromatic component known in the technical field, so long as it can exhibit the desired aromatic property and deodorant property. Such an aromatic material may include, for example, an oil-based aromatic component, an alcohol-based aromatic component, an aldehyde-based aromatic component, a ketone-based aromatic component, an ether-based aromatic component, an ester-based aromatic component, a lactone-based aromatic component or derivatives thereof. These aromatic components may also be included in any desired combinations. Among such aromatic components, those containing oil-based aromatic components are especially preferred from the viewpoint of excellent aromatic properties and deodorant properties, and excellent impregnation ability into the granules 1 containing the water-absorbing base material.

Examples of oil-based aromatic components include lavender oil, rose oil, rosemary oil, jasmine oil, carnation oil, patchouli oil, orange oil, lemon/lemongrass oil, grapefruit oil, lime oil, bergamot oil, vetiver oil, clove oil, zedan oil, sandalwood oil, cypress oil, eucalyptus oil, kassha oil, camphor oil, clove oil, ylangylang oil, citronella oil and geranium oil.

The aromatic material 2 containing such an oil-based aromatic component has a degree of impregnating ability that is suitable to allow the aromatic material 2 residing on the surfaces of the granules 1 (that is, the aromatic material 2 that has not been impregnated into the granules 1) to be transferred to each other on the surfaces, when the granules 1 are contacting each other, while the prescribed amount of aromatic material 2 is being impregnated into the granules 1, after the aromatic material 2 has been supplied to the granules 1. Consequently, in the steps downstream after the step of transferring, it is possible to eliminate the heated drying step that has been necessary in the prior art, and to thus improve production efficiency.

In addition, when an animal has excreted matter, the granules 1 release heat by moisture in the excreta, and the moisture evaporates by the heat, as the aromatic material 2 impregnated in the granules 1 is simultaneously released out of the granules 1, thereby suppressing the bad odor produced by the excreta.

Also, the aromatic material 2 may be added to the materials for disposal of animal excrement in any desired amount, according to the aromatic property that is desired. If the amount is too small, however, it will not be possible to obtain sufficient aroma, while if it is too large, on the other hand, the aroma will become too strong and may create unpleasantness or a health hazard, and therefore it is generally preferred for the aromatic material 2 to be used at a content in the range of 0.0001 to 20 mass % in the materials for disposal of animal excrement. The content is more preferably 0.001 to 10 mass % and most preferably 0.01 to 5 mass %.

According to the invention, the granules 1 are conveyed in the prescribed machine direction MD by desired conveying means 6, such as a belt conveyor. The conveying means 6 is not particularly restricted; however, it is preferred to use a belt conveyor to allow continuous conveying of large volumes of granules 1 and to facilitate supply of the aromatic material 2 to the granules 1. There are no particular restrictions on such a belt conveyor, and a rubber belt conveyor or steel belt conveyor known in the prior art may be used, or for example, a belt conveyor provided with a mesh belt may be used in consideration of eliminating liquid on the conveying surface.

When using a belt conveyor provided with a mesh belt, there are no particular restrictions on the aperture of the mesh belt, and one of any size may be used to match the sizes of the granules 1, however, particularly preferred is one having an aperture allowing passage of the aromatic material 2, or allowing passage of powder with a size smaller than the prescribed dimensions of the granules 1, such as an aperture of 200 mesh or greater.

The material of the conveyor belt is also not particularly restricted; however, it is preferred to use a material with excellent corrosion resistance or heat resistance, for example, one composed of a metal such as steel or stainless steel, or heat-resistant rubber or a heat-resistant synthetic resin.

Also for this aspect, as shown in FIG. 1 and FIG. 2, step I is carried out in which the aromatic material 2 is supplied through the supply nozzle 5 set above the conveying means 6, onto the granules 1 being conveyed by the conveying means 6, and the aromatic material 2 is partially adhered onto the granules 1.

Adhering the aromatic material while conveying the granules eliminates the need for an aromatic material-adhering step carried out by a batch process using a rotating stirring mixer, such as used in the prior art, and allows the production steps to be carried out continuously, thereby increasing the production efficiency for the production process (production quantity/time).

For this aspect, the aromatic material 2 is supplied to the granules 1 being conveyed by the conveying means 6; however, there is no restriction on the timing for supply of the aromatic material 2. In a different aspect, for example, the aromatic material 2 can be supplied to the granules 1 during the period after the granules 1 have fallen from the edge at the downstream end of the conveying means 6 before they are received into the vibrator 7 (that is, while the granules 1 are falling). According to yet a different aspect, the aromatic material 2 can be supplied to the granules 1 after the granules 1 have been received into the vibrator 7. Also, supply of the aromatic material 2 may be carried out over several operations, with the timing of each being in the desired combination.

According to the invention, the supply nozzle 5 for supply of the aromatic material 2 is not particularly restricted, and any form of supply may be employed, such as spraying, or intermittent or continuous dropping. The supply nozzle 5 is preferably a spray nozzle from the viewpoint of allowing uniform and efficient supply of the aromatic material 2 to the granules 1 spreading out on the conveying surface, without causing them to fly off.

As regards supply of the aromatic material 2, the supply conditions, such as the aromatic material 2 viscosity, supply rate and temperature, may be adjusted to adjust the amount of coverage of the aromatic material 2 on the granules 1. For example, if the viscosity of the aromatic material 2 is high, the droplets of the sprayed aromatic material 2 will be increased in size, and it will be possible to increase the amount of coverage adhering to each granule. If the viscosity of the aromatic material 2 is low, the droplets of the sprayed aromatic material 2 will be reduced in size, and it will be possible to adhere the aromatic material 2 to more of the granules 1, thus allowing a smaller amount of aromatic material 2 to be supplied and more effectively preventing fly-off of the aromatic material 2.

Also, the means for adjusting the coverage of the aromatic material 2 on the granules 1 may be adjustment or control of the conveying speed of the conveying means 6. By adjusting or controlling the conveying speed, it is possible to easily adjust or control the amount of coverage of the aromatic material 2 on the granules 1 to an amount suitable for allowing transfer, as described below.

Also in this aspect, a transferring step III is carried out in which, after the granules 1 to which the aromatic material 2 has partially adhered have passed through step II that accomplishes transport to a selected vibrator 7, such as a vibrating sieve, by conveying means 6, the granules 1 are vibrated at the vibrator 7 to transfer the aromatic material 2 adhered onto one granule 1 to another granule 1.

The granules 1 that have passed through step I in which the aromatic material 2 is partially adhered onto the granules 1 include, as shown in FIG. 2, granules 1 to which the aromatic material 2 has been partially adhered, and granules 1 with no adhering aromatic material 2. When such granules 1 are vibrated with the vibrator 7, one of the granules 1 to which the aromatic material 2 has partially adhered contacts or impacts with another granule 1 to which the aromatic material 2 has partially adhered or to a granule 1 without adhesion of aromatic material 2, and the aromatic material 2 adhering to the one granule 1 is transferred to the other granule 1 or to a granule 1 without adhesion of aromatic material 2. In addition, this transfer caused by vibration is repeated frequently, and granules 1 are formed with aromatic material 2 reliably adhering with a suitable degree of coverage.

Also, the transferring step III is carried out preferably not greater than 900 seconds, even more preferably not greater than 600 seconds and most preferably not greater than 180 seconds after step I in which the aromatic material 2 is partially adhered to the granules 1. By conducting the transferring step III not greater than 900 seconds after partially adhering the aromatic material 2 to the granules 1, it is possible to prevent excessive impregnation of the aromatic material 2 into the granules 1, formation of an easily degraded local aromatic material impregnation layer, drying of the aromatic material 2 adhered on the granules 1 and impediment thereof transfer to other granules 1. Consequently, the aromatic material 2 can be more reliably adhered onto the surfaces of the granules 1.

Also, the vibrator 7 used to vibrate the granules 1 is not particularly restricted so long as it can vibrate the granules 1, and any desired vibrator 7 may be used. The transferring step III preferably employs a vibrating sieve from the viewpoint of allowing the transferring step III to be carried out while removing powder attached to the granules 1 and excess aromatic material 2, while also allowing the transferring step III to be carried out simultaneously with the step of classifying the granules 1 based on the sizes thereof. By simultaneously carrying out the classifying step and transferring step III, it is possible to transfer the aromatic material to the granules 1 while removing off powder mixed with or adhering to the granules 1. As a result, since transfer of the aromatic material to the powder is reduced, the aromatic material stably adheres onto the granules 1. Furthermore, when the granules 1 are granules that have been compacted and granulated, powder is readily formed from the granules, and therefore using a vibrating sieve is particularly advantageous in such cases.

In addition, using a vibrating sieve provided with screening surfaces in two or more stages allows the step of classifying the granules 1 based on the sizes thereof to be carried out in a precise manner, and can facilitate adjustment of the particle sizes of the granules in the later packaging step.

Also, there are no particular restrictions on the vibration conditions, such as the form of the vibration surface of the vibrator or the frequency of vibration, and they may be appropriately determined according to sizes of the granules 1 and the desired state of transfer. In order to promote contact or impact between the granules 1, the vibration surface preferably includes an uneven shape.

Also, the vibration surface preferably includes a porous member, such as a wire mesh or punching plate. Using such a porous member on the vibration surface allows indirect transfer of the aromatic material 2 through the porous member, while also allowing removal of excess aromatic material and powder. The effect of the uneven shape is particularly notably when the vibration surface includes a wire mesh.

The frequency of vibrator is not particularly restricted, and generally a frequency in the range of 1-100,000 Hz may be used. From the viewpoint of vibrating all of the granules 1 on the vibration surface to increase the probability of contact or impact between the granules 1, the frequency is preferably in the range of 5-12,000 Hz and more preferably in the range of 10-80 Hz.

Furthermore, in the production method of the invention, it is possible to eliminate the heat drying or sifting steps that are carried out after the aromatic material adhering step in the prior art, so that the transferring step III may be followed by subsequent steps, such as a packaging step, without such steps.

Since the granules 1 to be obtained by the production method of the invention do not have an easily degraded local aromatic material impregnation layer on the surfaces of the granules 1, unlike conventional granules, but rather the aromatic material 2 reliably adheres onto the surfaces of the granules 1 with a suitable degree of coverage, it is possible to significantly improve the aromatic property or deodorant property of materials for disposal of animal excrement.

### EXAMPLES

The invention will be explained below in more detail based on examples, with the understanding that the invention is not limited to the examples.

### [Production of Granules]

Commercially available bentonite pellets (product of Unicharm Corp., “Sand with aromatic odor after urination” (product name)) were passed through a φ2 mm sieve, and the bentonite pellets remaining on the sieve were recovered to obtain a granule sample containing a water-absorbing base material.

### [Preparation of Aromatic Material Sample]

An aromatic material sample was prepared by mixing a fluorescent agent (“Keiko Panetol OF” (product name) by Taseto Co., Ltd.) at 3% based on mass, with a commercially available aromatic material (“TF-23960” by IFF Japan).

### Example 1

A 200 g portion of the granule sample was placed in a plastic bag and the plastic bag was set on the screening surface of a vibrating sieve. The mouth of the plastic bag was opened, 0.2 g of the aromatic material sample was dropped onto one location of the granule sample in the plastic bag, and after allowing it to stand for 3 seconds, the vibrating sieve was actuated at a frequency of 3600 VPM (60 Hz) to vibrate the granule sample in the plastic bag for 30 seconds. Next, the same operation, i.e. the operation of placing 200 g of granule sample in a plastic bag and then vibrating the granule sample in the plastic bag (hereunder referred to as “operation A”) was repeated 4 or 5 times, including the first time, to obtain an aromatic material-adhered sample in which the aromatic material sample had been mutually transferred.

### Examples 2 to 6

An aromatic material-adhered sample was prepared in the same manner as Example 1, except that the time from dropping of the aromatic material sample onto the granule sample in the plastic bag until the start of vibration of the granules was changed to 1 minute (Example 2), 3 minutes (Example 3), 5 minutes (Example 4), 10 minutes (Example 5) or 15 minutes (Example 6).

### Comparative Example 1

An aromatic material-adhered sample was prepared in the same manner as Example 1, except that the aromatic material sample was not vibrated after dropping onto the granule sample in the plastic bag.

### [Evaluation of Aromatic Material Coverage]

Each of the aromatic material-adhered samples of Examples 1 to 6 and Comparative Example 1 was reduced to approximately 10 g each using a divider, and the reduced sample was irradiated with a black light to confirm the aromatic material sample-adhered granules containing the fluorescent agent, while removing out only the fluorescent agent-adhering granule sample from the aromatic material-adhered sample. The weight of the removed granule sample was measured, and the ratio of the weight of the fluorescent agent-adhered granules with respect to the total weight of the granules before adhesion of aromatic material sample, i.e. the aromatic material-adhered granule ratio (%), was calculated for each time period after adhesion of aromatic material. Also, the average aromatic material-adhered granule ratio (%) was calculated as the average of the value of the aromatic material-adhered granule ratio calculated from the granule sample after transfer, obtained by repeating operation A (or in the case of Comparative Example 1, operation A without vibration, same hereunder) four times, and the value of the aromatic material-adhered granule ratio calculated from the granule sample after transfer, obtained by repeating operation A five times. The results for the average aromatic material-adhered granule ratio are shown in Table 1 below.

TABLE 1

| | Time to | Average aromatic |
|---|---|---|
| | transferring | material-adhered |
| | step¹⁾ | granule ratio (%) |
| Example 1 | After 3 seconds | 22.4 |
| Example 2 | After 1 minute | 21.3 |
| Example 3 | After 3 minutes | 20.3 |
| Example 4 | After 5 minutes | 14.8 |
| Example 5 | After 10 minutes | 9.5 |
| Example 6 | After 15 minutes | 8.5 |
| Comp. Example 1 | — | 3.1 |

¹⁾Time to transferring step: Time from partial adhesion of aromatic material onto granules until the start of vibration of granules.

As shown in Table 1, the average aromatic material-adhered ratio was low, at about 3.1%, in Comparative Example 1 in which no vibration was performed after dropping of the aromatic material sample, whereas in Examples 1 to 6 of the invention, the average aromatic material-adhered ratio was 8.5%, and therefore the obtained granules had aromatic material reliably adhered with a suitable degree of coverage. In addition, a shorter time from partial adhesion of the aromatic material to the granules until the step of transferring resulted in a higher average aromatic material-adhered granule ratio, the average aromatic material-adhered granule ratio being greater than 20% with a time of not greater than 180 seconds.

Exemplary aspects of the invention will be described below.

One aspect of the invention is a method of producing materials for disposal of animal excrement comprising an aromatic material and granules comprising a water-absorbing base material, comprising the steps of: partially adhering the aromatic material onto the granules, and transferring aromatic material adhered on one granule to another by vibrating the granules partially adhering the aromatic material.

According to another aspect of the invention, the step of transferring is carried out not greater than 900 seconds after completion of the step of partially adhering the aromatic material to the granules.

According to yet another aspect of the invention, the step of transferring includes using a vibrator for vibration of granules to which the aromatic material has been partially adhered.

According to yet another aspect of the invention, the step of transferring includes using a vibrating sieve for vibration of granules to which the aromatic material has been partially adhered, and removal of powder while classifying the granules according to size using the vibrating sieve.

According to yet another aspect of the invention, the step of transferring includes using a vibrator for vibration of granules to which the aromatic material has been partially adhered, and the vibration surface of the vibrator contains an uneven shape.

According to yet another aspect of the invention, the step of transferring includes using a vibrator for vibration of granules to which the aromatic material has been partially adhered, and the vibration surface of the vibrator contains a wire mesh.

According to yet another aspect of the invention, the vibration in the step of transferring includes vibration at a frequency of 5-12,000 Hz.

According to yet another aspect of the invention, the step of partially adhering the aromatic material onto the granules includes spraying the aromatic material onto the granules.

According to yet another aspect of the invention, the step of partially adhering the aromatic material onto the granules includes adjusting the aromatic material supply conditions so that the aromatic material partially adheres onto the granules.

According to yet another aspect of the invention, the step of partially adhering the aromatic material onto the granules includes adhering the aromatic material to the granules while the granules are being conveyed.

According to yet another aspect of the invention, the step of partially adhering the aromatic material onto the granules includes adjusting or controlling the granules conveying speed so that the aromatic material partially adheres onto the granules.

According to yet another aspect of the invention, the granules are granules obtained by granulation.

According to yet another mode of the invention, the water-absorbing base material contains at least one material selected from the group consisting of bentonite, acidic white clay, silica gel, diatomaceous earth, and derivatives thereof.

According to yet another aspect of the invention, the water-absorbing base material comprises bentonite and/or acidic white clay treated with an alkali metal.

According to yet another aspect of the invention, the aromatic material comprises at least one component selected from the group consisting of oil-based aromatic components, alcohol-based aromatic components, aldehyde-based aromatic components, ketone-based aromatic components, ether-based aromatic components, ester-based aromatic components, lactone-based aromatic components, and derivatives thereof.

According to yet another aspect of the invention, the materials for disposal of animal excrement obtained by the production method of the invention is materials for disposal of animal excrement comprising granules with aromatic material reliably adhering onto the surfaces with a suitable degree of coverage, without forming an easily degraded local aromatic material impregnation layer.

Incidentally, the production method of the invention is not restricted by the aspects and examples described above and can be appropriately modified within a range that is not outside of the object and gist of the invention.

### REFERENCE SIGN LIST

1 Granules
2 Aromatic material
3 Aromatic material impregnation layer
4 Aromatic material-rich powder
5 Supply nozzle
6 Conveying means
7 Vibrator
8 Section with partially adhering aromatic material

1. A method of producing materials for disposal of animal excrement comprising an aromatic material and granules comprising a water-absorbing base material, comprising the steps of:
partially adhering the aromatic material onto the granules, and
transferring aromatic material adhered on one granule to another by vibrating the granules partially adhering the aromatic material.

2. The method according to claim 1, wherein the step of transferring is carried out not greater than 900 seconds after completion of the step of partially adhering the aromatic material to the granules.

3. The method according to claim 1, wherein the step of transferring includes using a vibrator for vibration of granules to which the aromatic material has been partially adhered.

4. The method according to claim 3, wherein the vibrator includes a vibrating sieve, and the method includes removal of powder while classifying the granules according to size using the vibrating sieve.

5. The method according to claim 3, wherein the vibration surface of the vibrator contains an uneven shape.

6. The method according to claim 3, wherein the vibration surface of the vibrator contains a wire mesh.

7. The method according to claim 1, wherein the vibration in the step of transferring includes vibration at a frequency of 5-12,000 Hz.

8. The method according to claim 1, wherein the step of partially adhering the aromatic material onto the granules includes spraying the aromatic material onto the granules.

9. The method according to claim 1, wherein the step of partially adhering the aromatic material onto the granules includes adjusting the aromatic material supply conditions so that the aromatic material partially adheres onto the granules.

10. The method according to claim 1, wherein the step of partially adhering the aromatic material onto the granules includes adhering the aromatic material to the granules while the granules are being conveyed.

11. The method according to claim 10, wherein the step of partially adhering the aromatic material onto the granules includes adjusting or controlling the conveying speed of the granules so that the aromatic material partially adheres onto the granules.

12. The method according to claim 1, wherein the granules are granules obtained by granulation.

13. The method according to claim 1, wherein the absorbing base material contains at least one material selected from the group consisting of bentonite, acidic white clay, silica gel, diatomaceous earth, and derivatives thereof.

14. The method according to claim 1, wherein the water-absorbing base material comprises bentonite and/or acidic white clay treated with an alkali metal.

15. The method according to claim 1, wherein the aromatic material comprises at least one component selected from the group consisting of oil-based aromatic components, alcohol-based aromatic components, aldehyde-based aromatic components, ketone-based aromatic components, ether-based aromatic components, ester-based aromatic components, lactone-based aromatic components, and derivatives thereof.

16. Materials for disposal of animal excrement obtained by the method according to claim 1.
